(19) United States
(12) Patent Application Publication
(10) Pub. No.: US 2019/0043631 A1
(43) Pub. Date: Feb. 7, 2019

(54) METHOD FOR PREPARING RADIOACTIVE SUBSTANCE THROUGH MUON IRRADIATION, AND SUBSTANCE PREPARED USING SAID METHOD

(71) Applicant: RIKEN, Wako-shi, Saitama (JP)

(72) Inventors: Teiichiro MATSUZAKI, Wako-shi (JP); Hiroyoshi SAKURAI, Wako-shi (JP)

(21) Appl. No.: 16/075,065

(22) PCT Filed: Jan. 30, 2017
(86) PCT No.: PCT/JP2017/003226

§ 371 Date: Aug. 2, 2018

(30) Foreign Application Priority Data
Feb. 3, 2016 (JP) 2016-019334

(51) Int. Cl. G21G 1/10; G21G 4/08

(52) U.S. Cl. CPC G21G 1/10; G21G 2001/0036; G21G 4/08

(57) ABSTRACT

In order to prepare a useful radioactive substance from radionuclides included in high-level radioactive waste and the like, an embodiment of the present invention provides a method for preparing a radioactive substance including a muon irradiation step for obtaining a first radionuclide by causing negative muons to be incident onto a radioactive target nuclide and triggering a nuclear muon capture reaction. The prepared radioactive substance includes at least one of the first radionuclide and a second radionuclide that is at least one type of a descendant nuclide obtained from the first radionuclide through radioactive decay. An embodiment of the present invention also provides the radioactive substance.

### TECHNICAL FIELD

The present invention relates to a method for producing a radioactive substance obtained through muon irradiation and a substance to be produced therefrom. More specifically, the present invention relates to a method for producing a radioactive substance produced by causing a nuclear muon capture reaction with a radionuclide, and a substance produced therefrom.

### BACKGROUND ART

Radiation emitted by nuclear radioactive decay and nuclear reaction has been used for various purposes by utilizing radioactive isotope (RI) or a radionuclide whose lifetime is stochastically determined in accordance with quantum mechanics. One typical example of it is nuclear medicine. In nuclear medicine, a substance containing a radionuclide as a part of the chemical structure, or a radioactive substance is used, and a radiation imaging radiation has been adopted for a living body (in vivo), such as SPECT (Single Photon Emission Computed Tomography), PET (Positron Emission Tomography), and planar images. Nuclear medicine that has been performed includes medical treatment using irradiation from medications of RI for, e.g., pain relief and in vitro nuclear medical inspection using tracers without imaging. Radioactive substances in these applications are used for nuclear medicine and related inspection, such as examination to measure metabolic capability with a tracer that is administered to a living organism (including human), as it may accumulate to a specific lesion. Such examinations include medical treatment by internal irradiation, imaging, capturing of three-dimensional images, and the like.

Conventional methods for producing radionuclides are carried out by irradiating charged particles and neutrons using a cyclotron or a nuclear reactor, or by extracting them from fission products (“nuclear fission method”). Among them, when it comes to the manufacturing method using a cyclotron, charged particles such as protons, deuterium nuclei, or alpha particles (⁴He nuclei) accelerated to a very high energy by a cyclotron are utilized. In contrast, in the nuclear fission method using nuclear reactors, for example, a target raw material is exposed to neutrons in a nuclear reactor, and thereafter useful nuclides are chemically separated from irradiated target materials or nuclear fission products.

The supply chain of the radionuclide produced by nuclear reactors has never been well-prepared. In particular, although it is necessary for stable production of radionuclides in the nuclear fission method to operate a nuclear reactor for a long time, institutions taking care of radionuclide production are limited to 6 research institutions (NRU reactor in Canada, HFR reactor in Netherlands, BR2 reactor in Belgium, OSIRIS reactor in France, SAFARI-1 reactor in South Africa, and OPAL reactor in Australia). Actually, Japan relies on European and Canadian reactors for supply of ^{99m}Tc (⁹⁹Mo) (for simplicity, hereinafter referred to as “⁹⁹Mo supply” in the background section) that is consumed domestically. High-enriched uranium (HEU) as a raw material for the nuclear reactor of the Atomic Energy of Canada Limited (NRU reactor) has been exported from the United States to Canada partly on an exemption due to medical demand of ⁹⁹Mo supply; however, transportation of HEU is suspended. This is due to prevention of proliferation of nuclear related substances (hereinafter referred to as “nuclear nonproliferation”). The NRU reactor is planned to shut down in March 2018 while the Canadian government has abandoned its successor reactor plan. As for supply chain aspect, the supply of ⁹⁹Mo from Europe to Japan was greatly affected by stagnation of aerial transport due to a volcanic eruption in Iceland in 2010. The situation is similar for the United States.

Against this backdrop, one of the inventors of the present application has found a method for producing a radioactive material using a nuclear muon capture reaction (nuclear muon capture reaction, abbreviated as “NMCR” in this application) with a stable nuclide that does not exhibit radioactivity as a raw material (PTL1).

Meanwhile, disposal of discharged spent nuclear waste remains at issue in currently operated nuclear power generation for power supply. Various methods have been proposed for the management of spent nuclear waste from nuclear power plants, among which a method of reprocessing at reprocessing plants is called nuclear fuel cycle. Generally, spent nuclear waste is divided into three types at reprocessing plants in the nuclear fuel cycle. The first one is uranium and plutonium, which are reused as nuclear fuel in the spent radioactive wastes. The second is a high-level radioactive waste including minor actinides (MAs) and fission products (FPs), which are radioactive wastes that are not recycled as nuclear fuel. The third is the remaining low level radioactive wastes. For a high-level radioactive waste, in addition to geological disposal on the premise of long-term storage for tens of thousands of years, combining “partitioning (or 4-group partitioning)” and “transmutation technology” has also been conceived for the purpose of facilitating site location and management of the disposal site (NPL1 and NPL2). In the method of partitioning, the high-level radioactive waste is separated into four groups of nuclides and processed uniquely to each group. Of these groups, a group of radioactive wastes containing MAs and FPs has a higher concentration but with reduced amount than unpartitioned one, so it is possible to reduce the amount of substances to be stored in a glass solidification form or the like only by such partitioning. However, MAs and FPs still require long-term storage. Therefore, subjecting the group of radioactive wastes containing MAs and FPs to transmutation with an accelerator or the like for the purpose of reducing the long-half-life MAs, FPs or the like is called “partitioning and transmutation” technology (NPL1 and NPL2).

### CITATION LIST

### Patent Literature

PTL1: JP 2014-196997 A

### Non-Patent Literature

NPL1: Atomic Energy Commission [of Japanese Government], “Gunbunri/Shoumetushori Gijyutu Kenkyuukaihatsu Chokikeikaku (Long-Term Research and Development Plan on Partitioning and Transmutation Technology)” (in Japanese) [online] http://www.aec.go.jp/jicst/NC/senmon/old/backend/siryo/back21/sanko2.htm [Last retrieved: Nov. 2, 2015]

NPL2: Research Organization for Information Science and Technology, Genshiryoku Hyakkajiten ATOMICA (ATOMICA, An Encyclopedia of Nuclear Energy) “fractional partitioning” (in Japanese), [online], http://www.rist.or.jp/atomica/data/dat_detail.php?Title_No=05-01-04-01 [Last retrieved: December 2 1, 2015]

NPL3: Yasuji MORITA, Kenihci MIZOGUCHI, Isoo YAMAGUCHI, Takeshi FUJIWARA and Masumitsu KUBOTA, “Gunbunrihou No Kaihatsu: Syoukibojikken Niyoru 4 Gunn Gunbunri Purosesu Ni Okeru Tekunechiumu Kyodou No Kakunin (Development of Partitioning Method: Confirmation of Behavior of Technetium in 4-Group Partitioning Process by a Small Scale Experiment)” Japan Atomic Energy Research Institute, (in Japanese) [online], http://jolissrch-inter.tokai-sc.jaea.go.jp/pdfdata/JAERI-Research-98-046.pdf

NPL4: Hisamichi YAMABAYASHI, “Kokusanka ⁹⁹Mo/^{99m}Tc No Iryou Unyou Ni Mukete No Kadai-Kokusanka ⁹⁹Mo/^{99m}Tc No Seizoujyou No Kadai (Problems in Clinical Practice of Domestic Supply of ⁹⁹Mo/^{99m}Tc: Considerations on the Domestic Production of ⁹⁹Mo/^{99m}Tc)”, RADIOISOTOPES (in Japanese), Vol. 61 (2012) No. 9 p. 489-496, Japan Radioisotope Association, doi:/10.3769/radioisotopes.61.489

NPL5: Ryohei ANDO and Hideki TAKANO, “Shiyozumi Keisuiro Nenryo No Kakushu Sosei Hyoka (Estimation of LWR Spent Fuel Composition)”, JAERI-Research (in Japanese) 99-004, (1999), Japan Atomic Energy Research Institute, [online], http://jolissrch-inter.tokai-sc.jaea.go.jp/pdfdata/JAERI-Research-99-004.pdf [Last retrieved: Dec. 24, 2015] Disclosed with detailed data at http://nsec.jaea.go.jp/ndre/ndre3/trans/sf.html

### SUMMARY OF INVENTION

### Technical Problem

Among the above-mentioned conventional methods for producing radionuclides, the nuclear fission method has several problems inherent therein. First of all, the necessity of operating a nuclear reactor per se would become a hindrance to the stable supply. Furthermore, it requires HEU handling, therefore isolation and extraction work under high dose circumstance is unavoidable. Moreover, concerns over supply of raw materials such as HEU and over nuclear nonproliferation cannot be overcome. Furthermore, only limited facilities can handle these types of processing even if you take a look around the world. Also, when it comes to supply chain of the nuclides whose transportation time is limited due to half-life properties, the supply chain depends upon transportation circumstances by their nature so when the nuclides concerned are distributed via freight delivery. For these reasons, it is not always easy to maintain the supply chain of radionuclides for medical applications, so long as it solely relies on the nuclear fission method.

Differently from any of the above-mentioned methods for producing a radionuclide, the present invention provides a novel method for producing a radionuclide. As a result, the present invention contributes to the stable supply of radioactive substances that contains radionuclides.

### Solution to Problem

The inventors of the present application conceived of adopting a radionuclide for a raw material instead of a stable nuclide conventionally adopted for the raw material in a method for producing a radionuclide utilizing NMCR by a negative muon. That is, in one embodiment of the present invention, provided is a method for producing a radioactive substance comprising a muon irradiation step for obtaining a first radionuclide through a muon nuclear capture reaction by irradiating a target nuclide which is a radionuclide with negative muons, wherein the radioactive substance to be produced comprises at least one of the first radionuclide and a second radionuclide, the second radionuclide being a descendant nuclide obtained from the first radionuclide via radioactive decay.

Also, in one embodiment of the present invention, provided is a radioactive substance comprising at least one of a first radionuclide and a second radionuclide, the first radionuclide obtained through a muon nuclear capture reaction by irradiating a target nuclide with negative muons, and the second radionuclide being at least one descendant nuclide obtained from the first radionuclide via radioactive decay, wherein the target nuclide is a radionuclide.

The inventors of the present invention focus on spent nuclear fuels associated with nuclear power generation in light water reactors. The inventors note that radionuclides that can be used for raw materials of useful nuclide production with NMCR are contained at high concentration in a high-level radioactive waste that is remains of processed spent nuclear fuel in the nuclear fuel cycle. As long as a nuclear reactor for power generation such as a light water reactor is in operation at a nuclear power plant, such radioactive nuclide demand in nuclear medicine is secured and the problem concerning stable supply does not arise.

In particular, radioactive wastes are storable raw materials with sufficiently long half-life when an LLFP (long-lived fission product) contained in FPs is adopted for the target nuclide. Therefore, supply stability of the radioactive wastes would not always be necessary, and it is unlikely that we face a raw material shortage even if nuclear reactors for power generation are stopped for any reason.

Furthermore, in one embodiment of the present invention in which ⁹⁹Tc is selected for the nuclide of a raw material and then ^{99m}Tc is produced through NMCR, it is also possible to use ⁹⁹Tc that would be a recycled material.

A negative muon is an elementary particle and a type of lepton. In any of the embodiments of the present invention, negative muons are made incident on a target nuclide to cause a muon nuclear capture reaction.

A descendant nuclide is a nuclide exhibiting radioactivity which has undergone one or more stages of radioactive decay. Typically, it includes not only a daughter nucleus generated by some radioactive decay from a parent nucleus, but also another descendant nucleus generated from that daughter nucleus. In any aspect of the present invention, the number of generations is not limited. Radioactive decay through which such descendant nuclide is produced also includes a series of radioactive decays (decay series) that sequentially generate a plurality of radionuclides, such as the neptunium series, the thorium series, and the actinium series.

A radionuclide is a term used to distinguish and identify atomic nuclei exhibiting radioactivity with respect to their nuclear spin states as needed. When the first radionuclide and the second radionuclide are concerned in the present application, the first radionuclide refers to a radionuclide produced directly via the muon nuclear capture reaction. In contrast, the second radionuclide is a nuclide that is determined to be different from the first radionuclide when distinction is made, in terms of nuclear spin states if necessary. The second radionuclide itself is also radioactive, and it is at least one of descendant nuclides of the first radionuclide. In accordance with the definition of descendant nuclides, a daughter nucleus obtained by radioactive decay from a nuclide that is to be classified into a second radionuclide for a certain first radionuclide must also be classified into a second radionuclide from a view point of the first radionuclide.

A radioactive substance is a substance of any form including a radionuclide. Typical chemical forms of it may include an element of a radionuclide substance, a compound including a radionuclide as a part of its chemical structure irrespective of an inorganic or organic compound (radioactive compound), and an association product associated with a radionuclide or a radioactive compound, as well as their ionized cations or anions. Also, the physical form of the radioactive substance is not particularly limited and may be of any physical form including a solid, a liquid, a gas a supercritical fluid, a plasma, and a dilution thereof. In the present application, the physical form of the radioactive substance is not limited and may take any physical form, including a crystal, an amorphous solid, an ionic crystal, a molecular crystal, a powder, an aqueous solution, a non-aqueous solution, an ion, a complex, an association product, a low-molecular substance, polymer molecule, organic and inorganic compounds, and the like.

The process of producing radioactive materials may be broadly categorized into two types; the first type is to make the radionuclide generate radioactivity, to generate an artificial radionuclide or to generate artificially a natural radionuclide by some method, to increase the ratio of the target nuclide, or to reduce the proportion of nuclides that are not one to produce, whereas the second type is to make the radioactive substance containing the radionuclide (hereinafter, including the radionuclide element substance) into the one having the intended chemical structure. In the present application, any process having a nuclear reaction including the first type is referred to as production of radionuclide. It should be noted that the production of the radionuclide described in the present application can include chemical processing in addition to physical processing, in the same manner as conventional production processes of radionuclides.

### Advantageous Effects of Invention

In any of the embodiments of the present invention, a useful radionuclide can be produced by a muon nuclear capture reaction utilizing, for example, radioactive wastes originating from spent nuclear fuel of a nuclear power plant. This enables production of a radioactive substance containing a target nuclide through a process that has no uncertainty over the stable supply of raw materials. In addition, this enables production of ⁹⁹Mo-^{99m}Tc generator by using a recycled raw material of ⁹⁹Tc that is produced in ⁹⁹Mo-^{99m}Tc generator manufacturing process, ⁹⁹Tc found in unused chemicals after formulation, or ⁹⁹Tc produced in the generator after use.

### BRIEF DESCRIPTION OF DRAWINGS

FIG. 1 is an explanatory diagram illustrating NMCRs on the chart of nuclides in an embodiment of the present invention.

FIG. 2 is an explanatory diagram illustrating a nuclear fuel cycle.

FIG. 3 is an explanatory diagram illustrating a nuclear reaction on the chart of nuclides where Mo isotope is generated by NMCR that use ⁹⁹Tc for a target in an embodiment of the present invention.

FIG. 4 is a decay scheme diagram among nuclides with a mass number A=99 including ^{99m}Tc.

FIG. 5 is an explanatory diagram illustrating a schematic configuration of a manufacturing apparatus for manufacturing ⁹⁹Mo by NMCR adopting a liquid target material in an embodiment of the present invention.

FIG. 6 is an explanatory diagram illustrating an outline of a process for producing ⁹⁹Mo by a batch manufacturing process with NMCR in an embodiment of the present invention.

FIG. 7 is a schematic chart illustrating a process outline of ion exchange method for further processing a product obtained by batch processing in an embodiment of the present invention.

FIG. 8 is an explanatory diagram illustrating nuclear reactions on the chart of nuclides where Xe of a mass number of 133 is generated by NMCR in an embodiment of the present invention.

FIG. 9 is a decay scheme diagram between Xe and Cs of a mass number of 133.

FIG. 10 is a schematic configuration diagram illustrating an irradiation processing apparatus for manufacturing ¹³³Xe by NMCR adopting a liquid target material in an embodiment of the present invention.

FIG. 11 is a schematic configuration diagram illustrating an irradiation processing apparatus for producing ¹³³Xe by NMCR adopting a solid target material in an embodiment of the present invention.

FIG. 12 is a schematic configuration diagram illustrating a configuration of a Xe—Cs separation apparatus in an embodiment of the present invention.

FIG. 13 is an explanatory diagram illustrating a nuclear reaction on the chart of nuclides where a Rb isotope is generated by NMCR adopting ⁹⁰Sr target in an embodiment of the present invention.

FIG. 14 is a decay scheme diagram between Sr and Y having a mass number of 89.

### DESCRIPTION OF EMBODIMENTS

Hereinafter, embodiments related to the production of radioactive materials according to the present invention will be described with reference to the drawings. In the description common parts or elements throughout the drawings are denoted by the same reference numerals, unless otherwise mentioned. Note that materials, amounts of use, ratios, processing contents, processing procedures, elements and specific examples thereof describe in the following specific examples, application examples, nuclide-specific arguments can be appropriately changed without departing from the gist of the present invention. Therefore, the scope of the present invention is not limited to the contents of the following specific description. For the explanation, we first describe the negative muon nuclear capture reaction (NMCR), describe the radionuclide as the target nuclide, and then explain the representative nuclide.

1. Negative Muon Atomic Nuclear Capture Reaction (NMCR)

The negative muon nuclear capture reaction (NMCR), a nuclear reaction by negative muon utilized in this embodiment, has already been disclosed by one of the inventors of the present application (PTL1). The nature and use of the muon, the nuclear reaction mechanism, the method of generating the negative muon, and the NMCR by the negative muon, all of which are described there, are also adopted in the present embodiment. That is, in NMCR by negative muon, when a negative muon is incident on a target atom (hereinafter referred to as “target nuclide”), the negative muon that finally arrives at 1s orbital will be annihilated by spontaneous decay of the muon or will be captured into the nucleus before the annihilation. The phenomenon of this capture into nucleus is referred to as “muon nuclear capture”. What is utilized in this embodiment is a nuclear reaction (nuclear muon capture reaction (NMCR)) involving nuclear transmutation of the target nuclide resulting from the muon nucleus capture. Hereinafter, muon or p represents negative muon when it is merely described, unless otherwise noted.

The muon nuclear capture reaction (NMCR) includes a nuclear reaction in which the nucleus of the target raw material nuclide captures the muon, generating another element whose atomic number is smaller by one than that of target nucleus. The expression of NMCR in a nuclear reaction mode is written as

μ⁻+N(Z₀,A₀)→N′(Z₀−1,A₀)+v (Eq. 1).

Here, the atomic number is Z₀ (i.e., the proton number is Z₀), the mass number is A₀ (i.e., the sum of the proton number and the neutron number is A₀), N is a nucleus in general, and N′ is a new nucleus to be generated while atomic number Z₀ and the mass number A₀ are specified. The reaction scheme expressed in Eq. 1 is that muon ρ⁻ is captured by nucleus N of the target nuclide having atomic number Z₀ and mass number A₀, and then isobar nucleus N′ is generated whose atomic number is decreased by 1 to be Z₀−1, while a neutrino v is generated.

The actual NMCR includes several variations depending on the combination of the number of neutrons released during the reaction and the nucleon number of the generated nucleus. The first one is a reaction expressed by Eq. 1 and expressed as “(ρ⁻, v) reaction”. The second one is expressed as

μ⁻+N(Z₀,A₀)→N″(Z₀−1,A₀−1)+n+v (Eq. 2)

where N″ is a nucleus which is neither N nor N′. This is a reaction in which one neutron n is released and the mass number A₀ decreases by one. Moreover, another reaction, expressed as

μ⁻+N(Z₀,A₀)→N′″(Z₀−1,A₀−2)+2n+v (Eq. 3)

may occur in which two neutrons 2n are released and the mass number A₀ is decreased by two, where N′″ represents an atomic nucleus that is neither N, nor N′, nor N″. The reactions of Eqs. 1 to 3 are expressed briefly as follows:
0 neutron released:
   (μ⁻, v) reaction: N′ ((Z₀−1), A₀) generation,
1 neutron released:
   (μ⁻, n v) reaction: N″ ((Z₀−1), (A₀−1)) generation, and
2 neutrons released:
   (μ⁻, 2 n v) reaction: N′″ ((Z₀−1), (A₀−2)) generation.
      The same applies to the following. It is to be noted that which isotopes are actually produced in what proportion depends on the nucleus of the target nuclide and the structure of the nucleus generated.

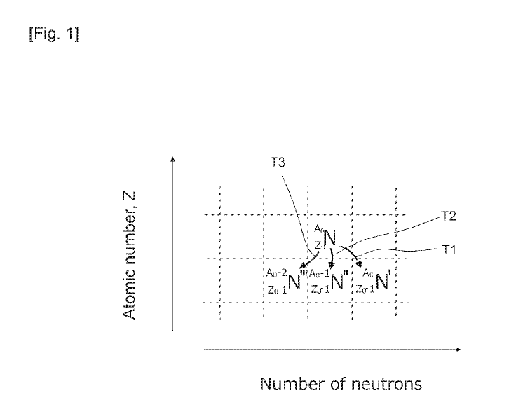

The reactions of NMCR formulated in the Eqs. 1 to 3 and so on can be explained on the basis of the chart of nuclides. FIG. 1 is an explanatory diagram illustrating NMCRs on the chart of nuclides in an embodiment of the present invention, where the atomic nucleus N portion on the chart of nuclides is enlarged with the atomic number Z on the vertical axis and the neutron number on the horizontal axis. The reaction (μ⁻, v) according to Eq. 1 generates atomic nucleus N′ that is located at a cell of one right column and one below row on the chart of nuclides with relative to the cell of nucleus N, the target nuclide to which muon μ⁻ collides. The nuclear reaction is indicated by path T1. Reactions through which neutrons are released such as (μ⁻, n v) and (μ⁻, 2n v) reactions according to Eqs. 2 and 3 correspond to ones that produce nuclei N″ and N′″ at shifted positions to the left of the cell from the one right column one below row for the nucleus N by the number of released neutrons. These nuclear reactions are indicated by paths T2 and T3, respectively. The explanation set forth herein is only for describing the positional relationship on the chart of nuclides. It does not mean intermediate nuclei under the path are generated sequentially. For example, N″ is generated without stopping at N′.

One of useful properties of NMCR is that there are few restrictions on the kinds of producible radionuclides, that is, most radionuclides can be produced. Any sort of radionuclide can be generated so long as a relevant target nuclide for the muon irradiation can be prepared. Another useful property of NMCR is that it can be caused with a very high degree of probability as long as a muonic atom can be formed. In other words, there is an extremely high probability that the nuclear reaction occurs comparing with one in a common nuclear reaction with neutron which is governed by a reaction cross-section (unit: barn). From these properties, it can be said that the production of radionuclide by NMCR has a high degree of freedom in selection of radionuclide, and can be carried out with significant efficiency. NMCR is advantageous also in the production capacity of nuclides.

In addition, advantages of use of muon can be found also in the practically important property that muon tends to be easily captured by atoms having a large atomic number, or atoms with more protons when plural sorts of atoms are irradiated by muons. Briefly, when an element having a small atomic number such as hydrogen, helium, carbon, nitrogen, oxygen or the like and a target nuclide having a large atomic number are contained in a substance, NMCR occurs at the target nuclide having a large atomic number with a high probability. Therefore, in a material to be irradiated that contains the target nuclide (hereinafter referred to as “target raw material”), the target nuclide is allowed to form a compound with an element having a smaller atomic number (“light element”) than that of the target nuclide, or to form an association product with a light element. The target nuclide can also be get mixed with another target nuclide or other target substance consisting of only light elements, dispersed in light elements, or even diluted with a diluent containing light elements only (e.g., helium gas or water). As a result, it is easy to change the production conditions according to various manufacturing requirements. As a typical example, NMCR can be caused with a target nuclide with a high probability even if a compound of a target nuclide and an element having a smaller atomic number than that of the target nuclide is adopted as the target raw material. For another typical example, it is also easy to cause the NMCR by bringing the target material into contact with or mixing with the fluid medium for the ease of transportation. These properties greatly enhance the practicality of radioactive materials and production of radionuclides that utilize NMCR.

Furthermore, the fact that radioactivity of the radionuclide produced is determined by the half-life of the radionuclide to be produced is also an advantageous property for facilitating the radionuclide production with NMCR. This property means that a radionuclide with a short half-life can be produced in a short period of time, whereas a long time is required for a radionuclide with a long half-life, when the same amount of radioactivity is to be produced.

In addition, difference in atomic numbers between the target nuclides and the generated radionuclide is useful at the time of separation and recovery of the radionuclide after production. This is because if the physical or chemical properties change with their atomic numbers, it becomes easy to separate the target nuclide in the target raw material and the generated radionuclide by way of a physical or chemical method.

Additional advantageous properties that facilitate the production of radionuclides in NMCR may be found in the fact that it is easy to automate by utilizing an appropriate conveying device and that the amount of radioactive substances that may become impurities is small.

2. Radionuclide for Target Nuclide

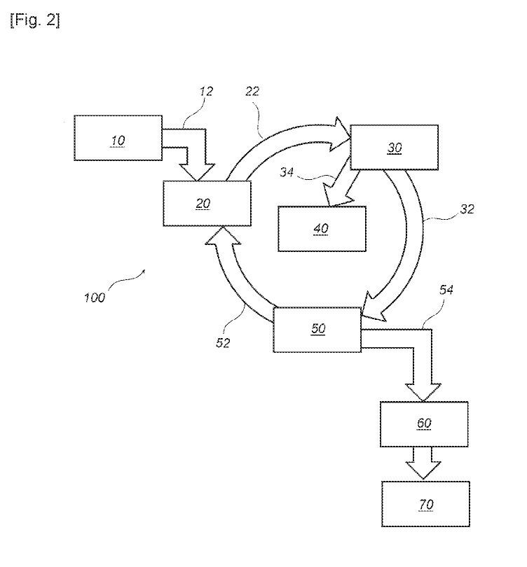

In the present embodiment, radionuclides are used for target nuclides of NMCR. The radionuclides can typically be extracted from a high level radioactive waste discharged from a reprocessing process for reprocessing spent nuclear fuel from nuclear power plants. FIG. 2 is an explanatory diagram illustrating the reprocessing system (nuclear fuel cycle) of spent nuclear fuel used in nuclear power plants. Table 1 also lists half-lives and masses of nuclides of fission products (FPs), which is a part of spent nuclear fuel, in mass content per ton. Of the FPs, radionuclides having a half-life of more than 200,000 years are also called long-lived fission products (LLFPs). Nuclides in FPs or LLFPs that can be used as raw materials for producing useful radionuclides by NMCR are described below. As indicated in the nuclear fuel cycle 100 in FIG. 2, fuel 22 to be used in the nuclear power plant 30 is uranium 12 which was mined from a uranium mine 10 and processed in a fuel processing plant 20. From a nuclear power plant 30 spent nuclear fuel 32 and a low level radioactive waste 34 are discharged. The low level radioactive waste 34 is disposed of in the low level radioactive waste disposal facility 40, whereas the spent nuclear fuel 32 is further sent to the reprocessing plant 50, where it is separated into recovered uranium or plutonium 52 and a high level radioactive waste 54. On one hand, the recovered uranium or plutonium 52 is sent to the fuel processing plant 20 again and is used for a so-called MOX fuel in power generation at the nuclear power plant 30. On the other hand, a high-level radioactive waste 54 is processed into a vitrified solidification body or the like, for example, and then sent to a high level radioactive waste storage facility 60, and finally is brought into under control at a high level radioactive waste disposal facility 70 for a long time.

TABLE 1

| | | |
|---|---|---|
| | | Content |
| Nuclide | Half-life | (per 1 ton) |

| | | | | |
|---|---|---|---|---|
| ⁷⁹Se | 295k | y | 6 | g |
| ⁹⁰Sr | 28.8 | y | 0.6 | kg |
| ⁹³Zr | 1.61M | y | 1 | kg |
| ⁹⁹Tc | 211k | y | 1 | kg |
| ¹⁰⁷Pd | 6.5M | y | 0.3 | kg |
| ¹²⁶Sn | 230k | y | 30 | g |
| ²¹⁹I | 15.7M | y | 0.2 | kg |
| ¹³⁵Cs | 2.3M | y | 0.5 | kg |
| ¹³⁷Cs | 30.1 | y | 1.5 | kg |

y: year,
M: 10⁶,
k: 10³

3. Details of Nuclides

Typical nuclides that can be used as raw materials for producing useful radionuclides through NMCR from the FPs and LLFPs are ⁹⁹Tc, ¹³⁴Cs, ¹³⁵Cs, and ¹³⁷Cs, and ⁹⁰Sr. As indicated in Table 1, a high-level radioactive waste contains high concentrations of ⁹⁰Sr, ⁹⁰Tc, ¹³⁵Cs, and ¹³⁷Cs. That is, ⁹⁹Mo is produced from ⁹⁹Tc, where ⁹⁹Mo is used for obtaining ^{99m}Tc, ¹³³Xe is produced from ¹³⁴Cs, ¹³⁵Cs, and ¹³⁷Cs, and ⁸⁹Sr is produced from ⁹⁰Sr. Details of combinations of these raw material nuclides and radionuclide to be produced will be described.

3-1. Production of ⁹⁹Mo from ⁹⁹Tc

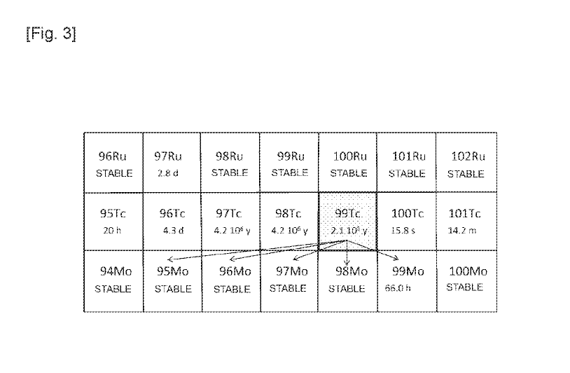

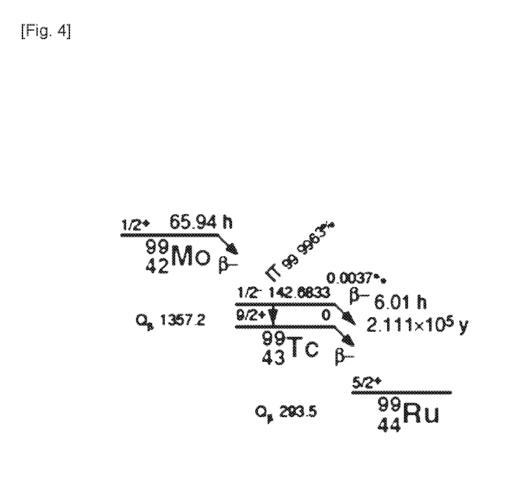

According to the present embodiment, ⁹⁹Mo can be produced from ⁹⁹Tc, which is a radionuclide. To produce a ⁹⁹Mo-^{99m}Tc generator ⁹⁹Mo (half-life: 66.0 h) is used, 82.4% of which decays by β⁻ decay into ^{99m}Tc. By gamma decay ^{99m}Tc decays into ⁹⁹Tc with a half-life of 6.02 hours with a property in which gamma ray of 140.5 keV is released, where ^{99m}Tc is used mainly in SPECT and is used for imaging agents for various organs, including brain imaging agent, thyroid function test agent, and parathyroid disease diagnostic agents. ^{99m}Tc is an important nuclide for organ scintigram, accounting for about 80% of the radionuclides consumption in nuclear medicine RI. There are some countries that rely on imports from abroad for all domestic consumption of ⁹⁹Mo-^{99m}Tc generators. The nuclear reaction in which Mo isotopes are generated by NMCR targeting ⁹⁹Tc is depicted on the nuclear diagram in FIG. 3. A decay scheme diagram regarding to ⁹⁹Mo-^{99m}Tc generator is illustrated in FIG. 4.

In the present embodiment, NMCR is used in a process to produce ⁹⁹Mo from target material of Tc containing ⁹⁹Tc. When NMCR targeting ⁹⁹Tc is performed, schemes of reaction become as follows:
⁹⁹Tc (μ⁻, v) ⁹⁹Mo,
⁹⁹Tc (μ⁻, n v) ⁹⁸Mo,
⁹⁹Tc (μ⁻, 2n v) ⁹⁷Mo,
⁹⁹Tc (μ⁻, 3n v) ⁹⁶Mo, and
⁹⁹Tc (μ⁻, 4n v) ⁹⁵Mo.

These schemes are also understood through transmutation traces on the nuclear diagram in FIG. 3. Among the Mo isotopes, ⁹⁹Mo is used for the ⁹⁹Mo-^{99m}Tc generator utilizing the decay illustrated in FIG. 4. In NMCR with ⁹⁹Tc as the target nuclide, all of ⁹⁵Mo-⁹⁸Mo among the producible isotopes of Mo are stable nuclei, and thus any other radioactive isotopes than ⁹⁹Mo is not found. That is, when ⁹⁹Mo is manufactured from ⁹⁹Tc by NMCR, only the intended nuclide is produced without producing any radioactive waste.

3-1-1. Production Amount of ⁹⁹Mo from ⁹⁹Tc by Transmutation of NMCR

Next, the estimation of the amount of ⁹⁹Mo produced by NMCR irradiated with muon will be described for the cases of two irradiation conditions. The amount (number count) of nuclide to be generated is called a muon transmutation rate N_{TM} and is calculated by the following equation:

N_{TM}=I_{μ-}×R_{c}×P_{NC}×P_{RBR},
where
I_{μ-}: number of muons/sec,
R_{c}: abundance of target nuclei,
P_{NC}: muon nucleus capture rate, and
P_{RBR}: branching ratio of muon nuclear capture reaction.
   The abundance R_{c} of the target nuclei is the proportion of the target nuclei in the target material for irradiation. The muon nuclear capture rate P_{NC} is the probability that muonic atoms are generated and muons are captured by the nucleus. The branching ratio P_{RBR} of the muon nuclear capture reaction is a factor depending on the numbers of neutrons released. In particular, R_{c}×P_{NC}×P_{RBR} is referred to as “reaction coefficient” in the present application. This reaction coefficient represents the transmutation efficiency per muon. It should be noted that the reaction coefficient and the muon transmutation efficiency do not include a reaction cross section. That is, since the muon can be stopped at the target nuclide, one muon can transmute one nucleus without fail. In other words, if a muon can be captured by the nucleus of the target material, one or more types of NMCR will necessarily occur at certain ratios. The ratios are relative proportions among the probabilities of occurrence caused by each of a plurality of NMCRs expressed as a (μ⁻, xn v) reaction with x being an integer of 0, 1, 2, 3, 4, 5, each of which for a target nuclide among them corresponds to the branching ratio P_{RBR} in the above. In addition, “without fail” in this context means that when capturing muons in a nucleus of the target material, at least one of the NMCRs explained above occurs, and the total of occurrence probabilities of NMCRs at that time is 100%. For this reason, NMCR has high production efficiency, and is a technique that requires only a short irradiation time for RI production.

The operating conditions of the apparatus for estimating the amount of ⁹⁹Mo produced are:
proton accelerator: 500 MeV, 5 mA, proton beam, and
the number of protons: 6.2×10¹⁸×(5/1000)=3.1×10¹⁶ number/sec.
   Furthermore, in order to estimate the intensity of the muons irradiated from the generated protons, the following assumptions were made:
Proton/negative muon conversion coefficient: 0.1 (10%), and
Muon transport efficiency: 0.01 (1%)
   As a result, the number of negative muons that can be irradiated is 3.1×10¹⁶×0.1×0.01=3.1×10¹³ counts/sec. As mentioned above, all muons are able to stop at the target material. In addition, it is assumed that nuclear absorption takes place for all negative muons from the 1 s state (P_{NC}=1.0) and nuclear transmutation occurs according to the probability of generating nuclei (reaction coefficient) via reaction branching.

Furthermore, the following assumptions were made regarding the branching ratio:
(μ⁻, v) reaction: 10%,
(μ⁻, n v) reaction: 50%,
(μ⁻, 2n v) reaction: 20%,
(μ⁻, 3 n v) reaction: 15%, and
(μ⁻, 4n v) reaction: 5%.
   That is, 10% of the NMCR was assumed to be involved in ⁹⁹Mo production. Note that the actual branching ratio is determined based on experiments. Furthermore, radioactivity of the generated nuclide after muon irradiation (unit: Bq) is given by

A_{RI}(t_{irradiation})=(number of muons)×(reaction coefficient)×(1−exp(−0.693/T_{1/2}×t_{irradiation})).

Here, T_{1/2} is the half-life of the producing nucleus, and t_{irradiation} is the muon irradiation time. Radioactivity after cooling is

A_{RI}(t)(t_{cooling})=A_{RI}(0)exp(−0.693/T_{1/2}×t_{cooling}).

Here, t_{cooling} is the cooling time, and A_{RI} (0) is the radioactivity when the muon irradiation is terminated.

3-1-1-1. Example Estimation for Longer Irradiation Time than the Half-Life of ⁹⁹Mo

Under the above assumption, ⁹⁹Mo production was estimated for irradiation of 5.5 days by NMCR which is twice the half-life of ⁹⁹Mo (66.0 hours). As a result, ⁹⁹Mo is generated by 2.33×10¹² Bq (2.33 TBq). This corresponds to 63.0 Ci in the unit once used for this purpose. Also, the isotope ratio of Mo after irradiation for 5.5 days is
⁹⁵Mo: 0.55%,
⁹⁶Mo: 16.50%,
⁹⁷Mo: 22.00%,
⁹⁸Mo: 55.01%, and
⁹⁹Mo: 5.95%.

The production volume per muon beam channel for generating NMCR under this condition will be described. ⁹⁹Mo produced by 5.5-day irradiation with muon is 7.97×10¹⁷ atoms, and its radioactivity is 2.33×10¹² Bq (2.33 TBq, 63.0 Ci). We assume that 82.4% of the ⁹⁹Mo nuclei decays into ^{99m}Tc nuclei. Since the decay constant of ^{99m}Tc is 3.198×10⁻⁵ for its half-life of 6.02 hours, its radioactivity is 2.10×10¹³ Bq (568 Ci). Assuming that the loss due to subsequent ion separation and recovery, pharmaceutical manufacture, transportation, radiation equilibrium, milking operation, etc. is 50%, the radioactivity of ^{99m}Tc that can be used as nuclear medicine RI is 1.05×10¹³ Bq (284 Ci). In this context, the amount for a dose is about 740 MBq (20 mCi). If this value is adopted, it is concluded that an amount corresponding to 14,200 doses can be manufactured for 5.5-day muon irradiation. If this process is carried out without any breaks, the amount that can be produced and used in one year is estimated by multiplying it 365/5.5=66.4 times, leading to 6.97×10¹⁴ Bq (18.8 kCi), which in turn corresponds to the number of administrations of about 940,000 doses. For example, the total amount of ^{99m}Tc used in nuclear medicine diagnosis in Japan is 900,000 per year (NPL4). Therefore, the demand of that scale can be covered with 1 muon beam channel. In addition, the ⁹⁹Tc raw material consumption amounts to 2.4 mg if it is calculated based on the consumption in 5.5-day irradiation. In reality, the amount of ⁹⁹Tc solid target having a required size (area and thickness) for efficiently stopping the negative muon on the ⁹⁹Tc solid target to produce ⁹⁹Mo is about 25 g. This amount of ⁹⁹Tc can be easily obtained from raw materials described below.

Next, specific radioactivity of ⁹⁹Mo obtained when the irradiation time is longer than the half-life of ⁹⁹Mo in this embodiment will be described. The specific radioactivity is a measure of radioactivity of ⁹⁹Mo in a certain amount of Mo (for example 1 g). After muon irradiation is performed for the 5.5 days as mentioned above, the content of ⁹⁹Mo in the produced Mo is 5.95%. As a result, 0.0595 g of ⁹⁹Mo is present in 1 g of Mo, whose number N of ⁹⁹Mo is calculated by using the mass number of Mo, where the mass number calculated from the isotope ratio of Mo produced is 97.50, in the following manner:

N=0.0595/97.50×6.02×10²³=3.67×10²⁰/g-Mo.

Based on this value, half-life of ⁹⁹Mo, T_{1/2}=66.0 h, and the decay constant λ of the ⁹⁹Mo=0.693/(66.0×3600)=2.92×10⁶ (sec⁻¹), the specific radioactivity R of ⁹⁹Mo is calculated as follows:

$$\begin{matrix}r = λ N = 1.07 \times {10}^{15} Bq \text{/} g \text{-} Mo \\ = 1 \text{,} 070 TBq \text{/} g \text{-} Mo .\end{matrix}$$

The specific radioactivity values to be compared are 370 TBq/g-Mo for specific radioactivity of ⁹⁹Mo obtained by the nuclear fission method and 0.074 TBq/g-Mo for the specific radioactivity of ⁹⁹Mo obtained in a neutron activation method targeting natural Mo as another method (NPL4). In other words, specific radioactivity of about 2.9 times the value of specific radioactivity of Mo obtained from the nuclear fission method is expected for ⁹⁹Mo produced by NMCR by selecting a radionuclide for the target nuclide. Thus, it can be concluded that it will show high usefulness in supplying a sufficient amount of ⁹⁹Mo, even using a small alumina column, as an example.

3-1-1-2. Example Estimation for Shorter Irradiation Time than the Half-Life of ⁹⁹Mo

A condition under which the specific radioactivity and production amount of ⁹⁹Mo are increased more efficiently than the above estimation is one that NMCR irradiation is performed for 1.0 day, which is about ⅓ of half-life (66.0 hours) of ⁹⁹Mo. The resultant ⁹⁹Mo amounts to 6.91×10¹¹ Bq (0.691 TBq, 18.7 Ci). The isotope ratios of Mo after the irradiation for 1.0 day are:
⁹⁵Mo: 0.53%,
⁹⁶Mo: 15.90%,
⁹⁷Mo: 21.20%,
⁹⁸Mo: 53.00%, and
⁹⁹Mo: 9.37%.
   Even when the irradiation time is set to 1.0 days, the same calculation as in the case of irradiation for 5.5 days is carried out to estimate specific radioactivity and production amount. The results are indicated in Table 2 in comparison with the irradiation value of 5.5 days.

TABLE 2

| NMCR Irradiation Time | 5.5 days | 1.0 day |
|---|---|---|
| ⁹⁹Mo Concentration, after the | 5.95% | 9.37% |
| Irradiation Time, per a Muon | | |
| Beam Channel | | |
| ⁹⁹Mo Production Amount, ″ | 2.33 × 10¹²Bq (62.2 Ci) | 6.91 × 10¹¹Bq (18.7 Ci) |
| | 7.97 × 10¹⁷ atoms | 2.37 × 10¹⁷ atoms |
| ^{99m}Tc Radioactivity, ″ | 2.10 × 10¹³Bq (568 Ci) | 6.24 × 10¹²Bq (169 Ci) |
| ^{99m}Tc Available Amount, ″ | 1.05 × 10¹³Bq (284 Ci) | 3.12 × 10¹²Bq (84 Ci) |
| | 14,200 doses | 4,200 doses |
| ^{99m}Tc Yearly Production | 6.97 × 10¹⁴Bq/y (18.8 kCi/y) | 1.14 × 10¹⁵Bq/y (30.8 kCi/y) |
| | 940k doses/y | 1.54M doses/y |
| ⁹⁹Tc Raw Material Consumption | 2.4 mg | 0.44 mg |
| ⁹⁹Mo Specific Radioactivity | 1,070TBq/g-Mo | 1,690TBq/g-Mo |
| | (2.9 times Nuclear Fission | (4.6 times Nuclear Fission |
| | Method) | Method) |

y: year,
T: 10¹²,
M: 10⁶,
k: 10³

In other words, compared with ⁹⁹Mo concentration of 5.95% for 5.5-day NMCR irradiation as described above, it is 9.37% for 1.0-day, or 1.57 times the ⁹⁹Mo concentration of 5.5-day irradiation. With respect to the production amount per muon beam channel, ⁹⁹Mo that can be manufactured for 1.0 day muon irradiation is 2.37×10¹⁷ atoms, whose radioactivity amounts to 6.91×10¹¹ Bq (0.691 TBq, 18.7 Ci). To reflect the fact that the number of manufacturing processes in one year will increase for repetitive manufacturing processes than in the case of 5.5-day irradiation, the production volume in the case of 1.0-day irradiation is multiplied by 5.5, which yields generated radioactivity increase of about 1.64 times. After all, 1.0-day irradiation enables ^{99m}Tc production of 1.14×10¹⁵ Bq (30.8 kCi) per year. The number of doses corresponding to this amount is about 1.54 million. The material consumption of ⁹⁹Tc required is calculated to be 0.44 mg by calculating the corresponding amount of ⁹⁹Tc for 1.0-day irradiation. This amount can be easily obtained from raw materials described below as in the case of irradiation for 5.5 days.

The specific radioactivity R of ⁹⁹Mo is calculated from the content of ⁹⁹Mo (9.37%) in the produced Mo when irradiated with muon for 1.0 days by the same calculation as

$$\begin{matrix}R = λ N = 1.69 \times {10}^{15} Bq \text{/} g \text{-} Mo \\ = 1 \text{,} 690 TBq \text{/} g \text{-} Mo .\end{matrix}$$

For ⁹⁹Mo produced by NMCR for 1.0 days by selecting a radionuclide for the target nuclide, we can expect specific radioactivity of about 4.6 times the specific radioactivity value of ⁹⁹Mo obtained from the nuclear fission method. Even under this irradiation condition, a sufficient amount of ⁹⁹Mo is supplied, so it can be said that it has high usefulness.

As described above, the method for generating ⁹⁹Mo from ⁹⁹Tc, a radionuclide, by nuclear transmutation through NMCR in the present embodiment shows sufficient practicability in the cases of shorter- and longer-MNCR irradiation time in comparison with ⁹⁹Mo half-life, and it is preferable in the method to set the MNCR irradiation time shorter than the half-life of ⁹⁹Mo.

In the following, the target material for obtaining ⁹⁹Tc for production of ⁹⁹Mo will be described, and the method for recovering ⁹⁹Mo will also be described. Among the isotopes of Tc, ⁹⁹Tc, which is useful as a target nuclide, is an artificial radionuclide and thus it is necessary to artificially manufacture it. There are two promising candidates for the ⁹⁹Tc source. One is a high-level radioactive waste obtained by reprocessing of spent nuclear fuel, and the other is a recycled material.

3-1-2. Production of ⁹⁹Mo from ⁹⁹Tc in High Level Radioactive Waste

A high-level radioactive waste contains ⁹⁹Tc at a certain rate of 1 kg per ton, and it is easy to isolate Tc from other metallic elements after the partitioning mentioned above followed by an additional processing. Also, in the situation after using UO₂ fuel at the burnup rate of 45 GWd/tHM in the pressurized water reactor (PWR) and cooling thereafter for 5 years, ⁹⁹Tc concentration in Tc isotopes contained in the spent nuclear fuel is 100 percent, i.e., Tc isotope of the other mass number is not included (NPL5). The ⁹⁹Tc is an LLFP with a half-life of about 210,000 years. In addition, the ⁹⁹Mo-^{99m}Tc generator can be produced from ⁹⁹Tc, a radionuclide of Tc in the spent nuclear fuel, by way of NMCR in accordance with the above principle.

The process of producing a ⁹⁹Mo-^{99m}Tc generator from a high level radioactive waste in spent nuclear fuel includes a step of extracting ⁹⁹Tc from a high level radioactive waste in the first place, a step of producing ⁹⁹Mo by NMCR in the second place, and a step of producing a ⁹⁹Mo-^{99m}Tc generator in the third place.

In the step of extracting ⁹⁹Tc from a high level radioactive waste, any chemical treatment and physical treatment can be adopted for implementing the present embodiment. One example of a method for separating nuclides currently being studied for a high-level radioactive wastes is a method called partitioning. For the partitioning, wet method (method using nitric acid) and some dry methods can be adopted. Here, for an example of the wet method, specific description will be set forth below based on the 4-group partitioning process (NPL1 and NPL2). A high level radioactive liquid waste, which is a high level radioactive waste, already contains nitric acid. Pretreatment is carried out by acting formic acid on it (denitration). Solvent extraction is carried out by applying a DIDPA (diisodecylphosphoric acid) solvent to the solution from which the precipitate has been removed. In the solvent extraction, when a solvent and an aqueous solution are placed in an identical container, elements which migrate from the aqueous solution layer to the solvent layer and which do not migrate can be separated, allowing the extraction. Among them, raffinate, a component remaining in the aqueous solution layer and does not migrate to the solvent layer, contains Tc. The raffinate is further reacted with formic acid and heated to precipitate (denitration precipitation). This precipitate is a group of partitioned 4 groups and contains Tc and platinum group. The other groups may be contained in each component separated so far or will be separated by additional operation. There is no particular obstacle to implementation by those skilled in the art.

From the Tc and the platinum group of the precipitate obtained in the denitration precipitation step, by further acting hydrogen peroxide (H₂O₂) on the dissolution, Tc can be dissolved in the aqueous solution with high yield and can be separated from the platinum group elements (Ru, Pd, Rh) (NPL3).

Next, ⁹⁹Mo is produced from ⁹⁹Tc by NMCR. For this purpose, a mixture of ⁹⁹Mo and Mo having stable nuclei can be produced by NMCR according to the reaction mode described above. In the case of using a high-level radioactive waste as a raw material, a process of elution with the nitric acid, the partitioning mentioned above, and the like allows us to employ ⁹⁹Tc aqueous solution (aqueous solution containing ⁹⁹TcO₄⁻ ion) extracted therefrom for the target material. By irradiating the muon for a time determined based on the half-life of ⁹⁹Mo, it is possible to generate ⁹⁹Mo efficiently. This irradiation time is, for example, 5.5 days which is twice the half-life (66 hours) of ⁹⁹Mo, or 1.0 days which is ⅓ of the half-life.

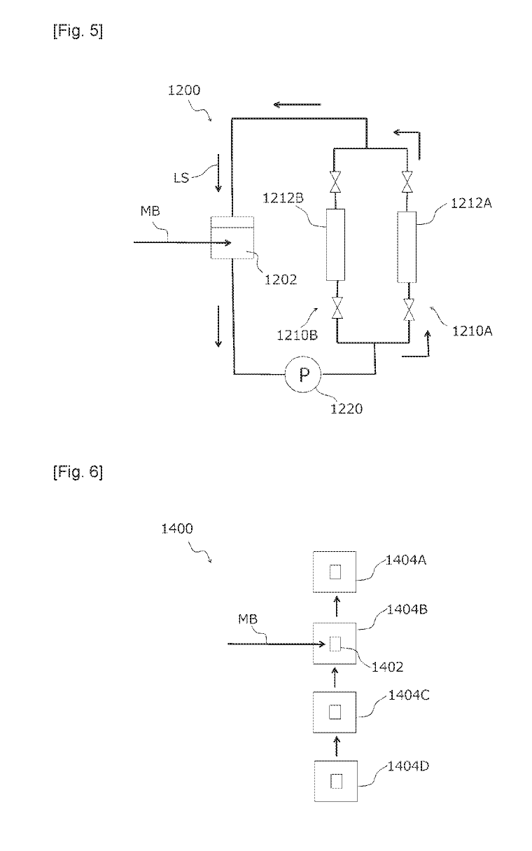

Specifically for NMCR and recovery and collection of generated ⁹⁹Mo, any method by one of the present inventors and disclosed in PTL1 can be adopted. For example, ion containing ⁹⁹Mo (hereinafter referred to as ⁹⁹Mo ion), typically ⁹⁹MoO₄²⁻ produced, is absorbed onto an ion exchange column (alumina column) and separated from a substance containing the ion having ⁹⁹Tc, such as ⁹⁹TcO₄⁻ (⁹⁹Tc ion) for recovery. FIG. 5 is an explanatory diagram illustrating a schematic configuration of a manufacturing apparatus 1200 for manufacturing ⁹⁹Mo by NMCR adopting a liquid raw material. In this method that employs a liquid material, Mo containing ⁹⁹Mo produced by NMCR is collected in the form of MoO₄²⁻ ion onto a column 1212A in a line 1210A or a column 1212B in a line 1210B. The columns at this time are selected to be an adsorption column or an ion-exchange column. Onto the columns 1212A and 1212B, MoO₄²⁻ is collected but ⁹⁹TcO₄⁻ is not captured due to the difference in electric charge. The alumina column adsorbs ions by electrostatic action, where Mo ion (MoO₄²⁻) is more significantly adsorbed in comparison with ^{99m}Tc nuclide or ⁹⁹Tc nuclide, which takes form of ^{99m}TcO₄⁻ or ⁹⁹TcO₄⁻ respectively. Therefore, the generated Mo can be efficiently collected while preventing ⁹⁹Tc from being mixed. That is, if the liquid target material 1202, which is an aqueous solution containing Mo ions at the irradiation position of the muon, is irradiated with the muon beam MB while circulating the liquid flow LS in the circulation path by an appropriate pump 1220, generated Mo ion is collected from the substance of the liquid flow LS discharged from the irradiation position due to the flow (the irradiated fluid) when it passes through the columns 1212A and 1212B. Furthermore, it is preferable that the ⁹⁹Tc ion will be reloaded, or repositioned into the irradiation position of the muon beam for the target nuclide of the muon due to the significant utilization efficiency of the raw material, even if there remains ⁹⁹Tc ion in the liquid flow LS that is not collected by the columns 1212A and 1212B. In this method adopting a liquid material, it is useful to arrange a plurality of columns such as Tc ion collecting columns 1212A and 1212B to make each other a standby system. It is to be noted that the frequency of replacing the columns 1212A and 1212B and recovering the Mo ions adsorbed thereon corresponds to the NMCR irradiation time in the case that ⁹⁹Mo is produced in the form of Mo ions by the manufacturing apparatus 1200. Estimates for this frequency to be once for every 5.5 days and for 1.0 days have been described in the section 3-1-1.

Thus, even if ⁹⁹Mo is produced in the target raw material containing Tc ion (⁹⁹TcO₄⁻), ⁹⁹Mo can be easily separated and collected from the target raw material by letting the columns 1212 A and 1212B such as an alumina column absorb ⁹⁹Mo ion (⁹⁹MoO₄²⁻). In addition, these columns themselves can be made of the same material as the column adopted for the ^{99m}Tc generator. This collection process is a totally inverted operation of an operation in the ⁹⁹Mo-^{99m}Tc generator where ⁹⁹Mo ions are absorbed to the ion exchange column (alumina column) and ^{99m}Tc ions generated by decay are eluted off by milking. Although stable nuclei ⁹⁵Mo-⁹⁸Mo can also be generated at the time of NMCR and even the Mo is mixed with ⁹⁹Mo, the purity of ^{99m}Tc eluted by the milking operation of ⁹⁹Mo-^{99m}Tc generator is not affected.

As another production example, a technique of a batch production process 1400 that employs a target material containing ⁹⁹Mo can also be employed. When irradiating muon continuously, the half-life of ⁹⁹Mo of 66 hours is not an obstacle. FIG. 6 is an explanatory diagram illustrating the outline of the process of producing ⁹⁹Mo by the batch manufacturing process 1400 by NMCR. Target raw materials that can be adopted this time are Tc₂O₇ solids or pertechnetate aqueous solutions, a certain amount of which is contained in one of appropriate containers 1404A to 1404D. The process of irradiating a unit amount of the target material 1402 with a predetermined dose of the muon beam MB for the batch processing is not only suitable for sequential processing by replacing the target material 1402 in each container, such as the containers 1404A to 1404D, but also able to be automated by using a transfer apparatus. For a unit amount of irradiated solid or liquid, necessary steps for separation process, formulation or the like can be performed thereafter. In the actual process, muonic atom X-rays and μ-e decay electrons can be measured from the outside, and muon incident energy can be optimized.

Contamination of the external environment is less likely to occur in batch processing, and there is an advantage that the outer container becomes a protective container for transport without any modification. It is also useful from a practical point of view as a method for manufacturing radioactive materials to process by NMCR while a substance having radioactivity is encapsulated in a container. For example, it is possible to transport ⁹⁹Mo after NMCR while sealing it as much as possible up until it is recovered or separated from the target material. In this embodiment in which all of the target nuclide ⁹⁹Tc, ⁹⁹Mo after generation, and ^{99m}Tc after generation are radioactive substances, the practicality of the production of radioactive substances by NMCR in batch processing is high from the viewpoint of radiation protection. ^{99m}Tc ions generated during transport can be easily chemically separated from ⁹⁹Mo ions. The target material 1402 inside the containers 1404A to 1404D in FIG. 6 can be either solid or liquid. Furthermore, in the batch manufacturing process 1400, although only a single container (here, the container 1404B) is indicated for a target of NMCR at a time, it is possible to make various modifications such as simultaneous irradiation to a plurality of containers 1404 by distributing muon beams according to implementation requirements.

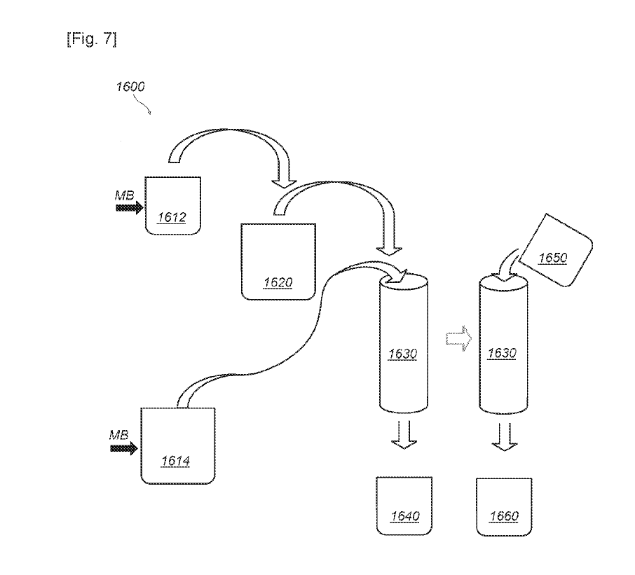

FIG. 7 is a schematic chart illustrating outline of a process 1600 for further processing the product obtained by the batch processing, indicating cases where a solid ⁹⁹Tc target is adopted and a liquid ⁹⁹Tc target is adopted, based on the example of a product containing Mo ions. In the processing process 1600, when a solid ⁹⁹Tc target 1612 is used for the muon beam MB irradiation, an aqueous solution 1620 is prepared by dissolving the solid ⁹⁹Tc target after the irradiation in which ⁹⁹Mo is generated with an appropriate acid or the like to generate ⁹⁹Mo-⁹⁹Tc ion. For ease of dissolution, it is preferable that the solid ⁹⁹Tc target 1612 has been made into a fine powder in advance. In the case the liquid ⁹⁹Tc target 1614 is used for the muon beam MB irradiation, an aqueous solution corresponding to that aqueous solution has been used from the muon irradiation step and is adopted as it is. In order to separate ⁹⁹Tc ions and ⁹⁹Mo ions from each other in the aqueous solution 1620 and the liquid ⁹⁹Tc target 1614, it is convenient to adopt an ion separation column 1630 such as an alumina column similar to FIG. 5. As a result, ⁹⁹Mo ion is collected onto the ion separation column 1630 and ⁹⁹Tc ion passes through it while staying in the aqueous solution. The aqueous solution 1640 containing the ⁹⁹Tc can be recycled as a liquid ⁹⁹Tc target, or a solid ⁹⁹Tc target can be produced therefrom by appropriate chemical treatment or physical treatment for reuse. Since ⁹⁹Mo is adsorbed onto the ion separation column 1630 at this stage, it is useful to utilize itself for a ⁹⁹Mo-^{99m}Tc generator. In addition, when it is necessary to release ⁹⁹Mo from the ion separation column, it is possible to elute ⁹⁹Mo from the ion separation column to obtain an aqueous solution 1660 in a form of ⁹⁹MoO₄²⁻ ion, or in another form containing ⁹⁹Mo, by letting an eluent 1650 (e.g., aqueous sodium hydroxide solution) pass through an ion separation column. it is possible to make the obtained ⁹⁹Mo into another chemical form suitable for further processing, or it is possible to employ any known chemical manipulation or physical manipulation method already known in the art.

The product containing Mo ions obtained by the batch processing can be separated by a precipitation method or coprecipitation method in addition to the ion exchange method. The precipitation method (and coprecipitation method) that can be adopted is similar to the method used for ordinary chemical separation. It is possible to make the obtained ⁹⁹Mo into another chemical form suitable for further processing, or it is possible to adopt any known chemical manipulation or physical manipulation method already known in the art.

Once a necessary amount of ⁹⁹Mo is obtained for ⁹⁹Mo-^{99m}Tc generator from a high level radioactive waste, it is no longer necessary to operate the nuclear reactor using HEU to obtain ⁹⁹Mo for the sake of ⁹⁹Mo-^{99m}Tc generator. In this regard, the present method of using a high-level radioactive waste as a raw material greatly contributes to the establishment and maintenance of the supply chain of ⁹⁹Mo-^{99m}Tc generator.

3-1-3. Manufacture of ⁹⁹Mo from Recycled Raw Material of ⁹⁹Tc

In the process of actually producing ^{99m}Tc and ⁹⁹Mo, which amount to the most part of the nuclides used in nuclear medicine applications, ⁹⁹Tc can be easily obtained from a by-product in the manufacturing process of the generator for milking, unused chemicals after formulating ^{99m}Tc, and used generators per se. There is no particular difficulty in using such ⁹⁹Tc for a target nuclide in the present embodiment. A recycled raw material containing ⁹⁹Tc in the present embodiment means, among substances containing ⁹⁹Tc, ⁹⁹Tc that is produced as a by-product in an arbitrary step up until ⁹⁹Mo-^{99m}Tc generator is produced, ⁹⁹Tc obtained by leaving unused drugs after formulation, or ⁹⁹Tc produced by radioactive decay in the ⁹⁹Mo-^{99m}Tc generator. Since ⁹⁹Tc of the nuclide as a raw material needs to be artificially obtained by some method, the substance containing ⁹⁹Tc should be substantially one manufactured in connection with the ⁹⁹Mo-^{99m}Tc generator, except for the radioactive waste mentioned above. The ⁹⁹Tc in the case of a nuclide of the recycled raw material means ⁹⁹Tc as explained above, while excluding ⁹⁹Tc that has been produced via ^{99m}Tc once produced for ⁹⁹Mo-^{99m}Tc generators and then administered to the human body or the like for their inherent purpose. The manufacturing process for producing ^{99m}Tc that lead to a ⁹⁹Tc nuclide used for the recycled material can be carried out not only by the conventional method but also by the method of any of the embodiments, though it may not be limited specifically. For example, the aqueous solution 1640 containing ⁹⁹Tc after passing through the ion separation column illustrated in FIG. 7 is an example of the recycled material.

FIG. 4 is a decay scheme diagram among nuclides with a mass number A=99 including ^{99m}Tc. FIG. 4 indicates ⁹⁹Tc (ground state with nuclear spin J=9/2+) obtained through ^{99m}Tc. Since ^{99m}Tc becomes ⁹⁹Tc with a half-life of 6.02 hours, ⁹⁹Tc is inevitably generated when handling ⁹⁹Mo-^{99m}Tc generator. Therefore, ⁹⁹Tc for the recycled raw material can be obtained at any process for producing ⁹⁹Mo-^{99m}Tc generator, at the site where ^{99m}Tc is actually used, or from the used ⁹⁹Mo-^{99m}Tc generators that have been returned for storage. Both ⁹⁹Mo and ^{99m}Tc manufactured for ⁹⁹Mo-^{99m}Tc generators for medical purposes are usually radioactive materials that are subject to radioactive control, though ⁹⁹Tc derived from these nuclides exhibits low radioactivity. For this reason, control of ⁹⁹Tc manufactured for medical purpose is maintained and most of it is returned. In this embodiment, since ⁹⁹Tc exhibiting radioactivity is used for a target nuclide for NMCR, any material including such ⁹⁹Tc can be adopted as a target material.

In carrying out the present method using recycled raw materials, there is no need to newly obtain nuclides by the nuclear fission method or nuclides from the high-level waste as in the present embodiment. Therefore, looking at the entire supply chain of ⁹⁹Mo-^{99m}Tc generators for medical purposes, if this method of using recycled raw materials is implemented, the necessity of implementing a method to handle a high level radioactive waste is mitigated, though it cannot be totally removed. In this regard, the present method using recycled materials greatly contributes to the establishment and maintenance of the supply chain of ⁹⁹Mo-^{99m}Tc generators.

3-2. Production of ¹³³Xe from ¹³⁴Cs, ¹³⁵Cs, and ¹³⁷Cs

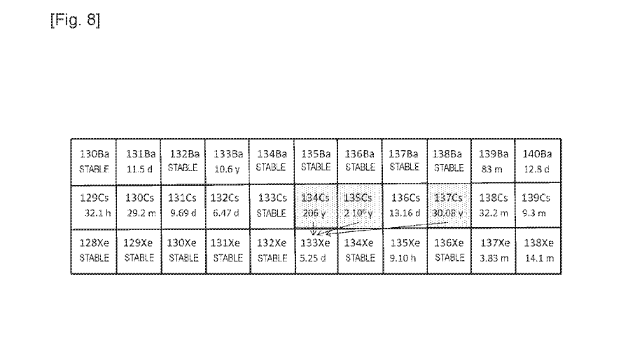

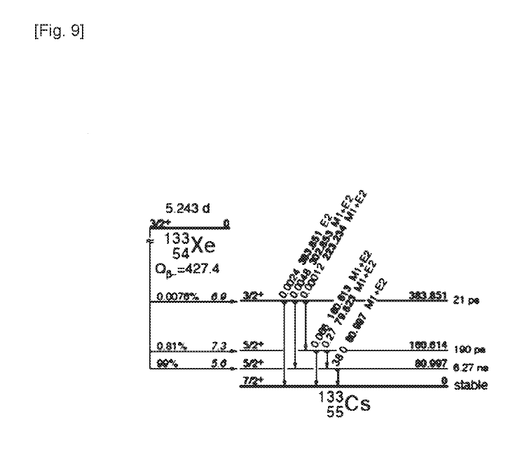

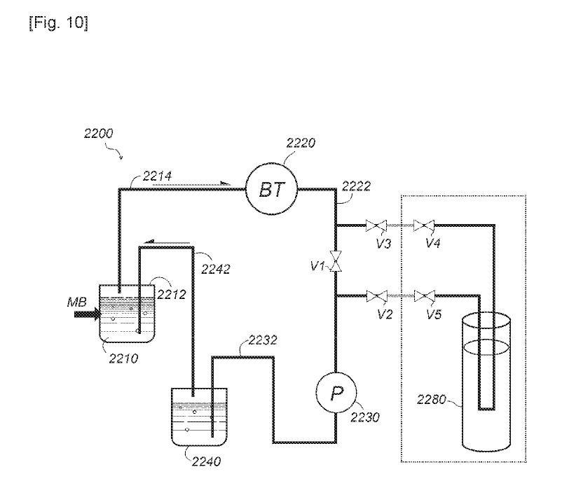

It is possible to manufacture ¹³³Xe from Cs raw material containing ¹³⁵Cs, ¹³⁷Cs, which are LLFPs contained in a high level radioactive waste. FIG. 8 is an explanatory diagram illustrating nuclear reactions on the chart of nuclides in which Xe having a mass number of 133 is generated by NMCR. In the production of ¹³³Xe, Xe gas containing ¹³³Xe is separated and recovered for use as nuclear medicine RI. It should be noted that ¹³³Xe is used for pulmonary function test and cerebral blood flow test. FIG. 9 is a decay scheme diagram between Xe and Cs of a mass number of A=133. In a typical nuclear medicine application of ¹³³Xe, gamma rays at 81 keV are measured with SPECT. The amount for a dose is about 370 MBq (10 mCi). Also, as an example, Japan's demand of ¹³³Xe is covered by imports. ¹³⁵Cs has a half-life of 2.3×10⁶ years, and ¹³⁷Cs has a half-life of 30.08 years. We also considered ¹³⁴Cs which is not an LLFP but has a half-life of 2.06 years. In particular, ¹³⁵Cs, ¹³⁷Cs are contained, 0.5 kg and 1.5 kg respectively in 1 ton of a high-level radioactive waste.

In the situation after UO₂ fuel is used at a burnup of 45 GWd/tHM in a pressurized water reactor (PWR) and after cooling for 5 years, the ratio of isotopes of Cs contained in spent nuclear fuel is
¹³³Cs: 42.1%,
¹³⁴Cs: 1.02%,
¹³⁵Cs: 14.8%,
¹³⁶Cs: 0.0%, and
¹³⁷Cs: 42.1%
   (NPL5). Note that the natural abundance ratio of Cs is 100%¹³³Cs.

The reaction modes of NMCR with ¹³⁷Cs as the target nuclide are as follows:
¹³⁷Cs (μ⁻, v) ¹³⁷Xe,
¹³⁷Cs (μ⁻, n v) ¹³⁶Xe,
¹³⁷Cs (μ⁻, 2n v) ¹³⁵Xe,
¹³⁷Cs (μ⁻, 3n v) ¹³⁴Xe, and
¹³⁷Cs (μ⁻, 4n v) ¹³³Xe.
   Also, those with ¹³⁵Cs as the target nuclide are as follows.
¹³⁵Cs (μ⁻, v) ¹³⁵Xe,
¹³⁵Cs (μ⁻, n v) ¹³⁴Xe,
¹³⁵Cs (μ⁻, 2n v) ¹³³Xe,
¹³⁵Cs (μ⁻, 3n v) ¹³²Xe, and
¹³⁵Cs (p, 4n v) ¹³¹Xe.
   Of generated Xe Isotopes ¹³⁶Xe, ¹³⁴Xe, ¹³²Xe, ¹³¹Xe are stable nuclei, but ¹³⁷Xe decays by β⁻ decay into ¹³⁷Cs with a half-life of 3.83 minutes, ¹³⁵Xe decays by β⁻ decay into ¹³⁵Cs with a half-life of 9.10 hours, and ¹³³Xe decays by β⁻ decay into ¹³³Cs (stable) with a half-life of 5.25 days. Since a neutron emission level is found for ¹³⁷Xe and a phenomenon that the neutron absorption cross section becomes huge (phenomenon known as xenon override in power control of the nuclear reactor) may occur for ¹³⁵Xe, it is possible that probability of generation of ¹³⁶Xe increases.

The reaction coefficient of each Cs isotope generated by NMCR was calculated based on the values for the reaction coefficient mentioned above. The beam condition and reaction branching ratio at that time were assumed to be identical to those for ⁹⁹Tc. The produced Xe isotopes have mass numbers ranging from 129 to 137, and Xe of each mass number is generated from Cs having a different mass number. The radioactive Xe nuclide having a relatively long half-life included in the remaining Xe gas is ¹³³Xe only. Gas containing ¹³³Xe is separated and recovered for use as nuclear medicine RI.

The reaction coefficients were calculated using all combinations of the Cs isotopes and Xe isotopes mentioned above. For example, the reaction modes leading to the target ¹³³Xe are:
¹³³Cs (μ⁻, v) ¹³³Xe,
¹³⁴Cs, (μ⁻, n v) ¹³³Xe,
¹³⁵Cs (p, 2n v) ¹³³Xe, and
¹³⁷Cs (p, 4n v) ¹³³Xe.
   The nuclear reaction diagram is illustrated in FIG. 8. Note that we omit those other than of a mass number of 133. Distribution among isotopes of the reaction coefficients for Xe of each mass number estimated based on the reaction branching ratio and abundance ratio was obtained as follows:
¹²⁹Xe: 0.0211,
¹³⁶Xe: 0.0637,
¹³¹Xe: 0.0931,
¹³²Xe: 0.2347,
¹³³Xe: 0.0978,
¹³⁴Xe: 0.1382,
¹³⁵Xe: 0.0990,
¹³⁶Xe: 0.2105, and
¹³⁷Xe: 0.0421.

3-2-1. Process (Outline)

The process of producing ¹³³Xe by NMCR from ¹³⁴Cs, ¹³⁵Cs, and ¹³⁷Cs in a high level radioactive waste is carried out by the following three steps:
Step 1: muon irradiation,
Step 2: cooling (first), and
Step 3: cooling (second).
   In Step 1, muon irradiation is performed on the target material of Cs containing ¹³⁴Cs, ¹³⁵Cs, and ¹³⁷Cs for 5.5 days (about 1 half-life of ¹³³Xe). The radioactivity at that time is estimated as:
¹³³Xe (5.25 days): 1.57×10¹² Bq,
¹³⁵Xe (9.10 hours): 3.07×10¹² Bq, and
¹³⁷Xe (3.83 min): 1.31×10¹² Bq.
   Note that Xe of other mass numbers are stable, exhibiting no radioactivity, though they are generated according to their reaction coefficients.

In Step 2, as the first cooling, 1 hour cooling is carried out after muon irradiation. At this time, the half-life of ¹³⁷Xe is 3.83 minutes, thus the 1 hour cooling period corresponds to 15.7 half-lives. With so much time, the majority of ¹³⁷Xe decays by β⁻ decays into ¹³⁷Cs (LLFP). The ¹³⁷Cs can be separated and recovered in an aqueous solution. The ratio of the number of isotopic atoms of Cs on completion of Step 2 is:
¹³³Cs: 33.7%,
¹³⁴Cs: 0.0%,
¹³⁵Cs: 63.5%,
¹³⁶Cs: 0.0%, and
¹³⁷Cs: 2.6%.
   In terms of the radioactivity ratio, ¹³⁷Cs accounts for 100%.

In Step 3, the second cooling is performed for a longer period (for example, 4 days). The period of 4 days corresponds to 10.5 half-lives of ¹³⁵Xe. Since the half-life of ¹³⁵Xe is 9.10 hours, most part of it decays by β⁻ decay into ¹³⁵Cs (LLFP) in the end. The ¹³⁵Cs can be separated and recovered in an aqueous solution. The ratio among the number of isotopic atoms on completion of Step 3 is:
¹³³Cs: 74.3%,
¹³⁴Cs: 0.0%,
¹³⁵Cs: 25.7%,
¹³⁶Cs. 0.0%, and
¹³⁷Cs: 0.0%.
   In terms of the radioactivity ratio, ¹³⁵Cs accounts for 100%. Likewise, the ratio of the number of isotopic atoms of Xe on completion of Step 3 is:
¹²⁹Xe: 2.63%,
¹³⁰Xe: 7.94%,
¹³¹Xe: 11.60%,
¹³²Xe: 29.25%,
¹³³Xe: 5.11%,
¹³⁴Xe: 17.23%,
¹³⁵Xe: 0.00%, and
¹³⁶Xe: 26.24%.
   ¹³³Xe content in Xe gas is 5.11%. Furthermore, the radioactivity ratio of ¹³³Xe accounts for 99.8%, and the radioactivity is 9.23×10¹¹ Bq (24.9 Ci).

Using the mass number (133.00) calculated from the isotopic distribution of generated Xe, the number of ¹³³Xe in 1 g of generated Xe is calculated to be 2.31×10²⁰/g-Xe. Furthermore, using the half-life of ¹³³Xe (T₁₁₂=5.25 days), the specific radioactivity of ¹³³Xe becomes 353 TBq/g-Xe. The specific radioactivity to be compared is 370 TBq/g-Mo of the specific radioactivity of ⁹⁹Mo obtained by the nuclear fission method (NPL4).

The production volume of ¹³³Xe per muon channel is 9.23×10¹¹ Bq (24.9 Ci). Since the amount for a dose to a patient is 370 MBq (10 mCi), the production volume corresponds to about 2,500 doses.

3-2-2. Details of Process

For implementing the process of producing ¹³³Xe by NMCR from ¹³⁴Cs, ¹³⁵Cs, ¹³⁷Cs, two candidates seem promising: the same method as the batch production process 1400 for ⁹⁹Mo illustrated in FIG. 6, and an on-line manufacturing method. For both cases, liquid targets and solid targets containing Cs are adopted. Solids that can be adopted as the solid target are listed with brief annotations on characters and properties:
cesium hydroxide (CsOH, colorless, hygroscopic),
cesium carbonate (Cs₂CO₃, white powder),
cesium nitrate (CsNO₃, white solid, water insoluble), and
cesium chloride (CsCl, solid).
   In the form of these simple substances or mixtures, solids containing ¹³⁴Cs, ¹³⁵Cs, ¹³⁷Cs can be extracted from a high level radioactive waste. On the other hand, typical liquid targets are listed with solubility in the following:
cesium hydroxide (CsOH, solubility 395 g/100 cm³, 15° C.),
cesium carbonate (Cs₂CO₃, solubility 260.5 g/100 cm³, 15° C.), and
cesium chloride (CsCl, solubility 162 g/100 ml).
   Liquid targets can also be extracted from a high level radioactive waste as simple substances or mixtures in the form of an aqueous solution containing ¹³⁴Cs—, ¹³⁵ Cs—, and ¹³⁷Cs ions.

In the case of the batch processing, a typical solid target or liquid target is irradiated with muons as a target material. Apparatus configuration for this process is almost the same as that of FIG. 6. The target raw material of cesium nitrate solid or cesium hydroxide aqueous solution is stored in a container (inner sealed container, not shown in FIG. 6). At this time, the remaining internal volume of the inner sealed container is replaced with high-purity helium gas. The inner sealed container is stored in a container 1404 (FIG. 6) which is an outer container, and muon irradiation is performed from the outside. As a result, the target ¹³³Xe gas can be obtained in the next step by separating the Cs ions and the rare gas of Xe. Muon incident energy can be optimized by measuring muonic atom X-rays and μ-e decay electrons. In this method, the outer container can be transported as it is to the next process while being used for a protective transportation container, which substantially prevents contamination of the external environment. In the method using the target material container, it is possible to irradiate sequentially by using a large number of target material containers, which is advantageous in that automation can be easy realized.

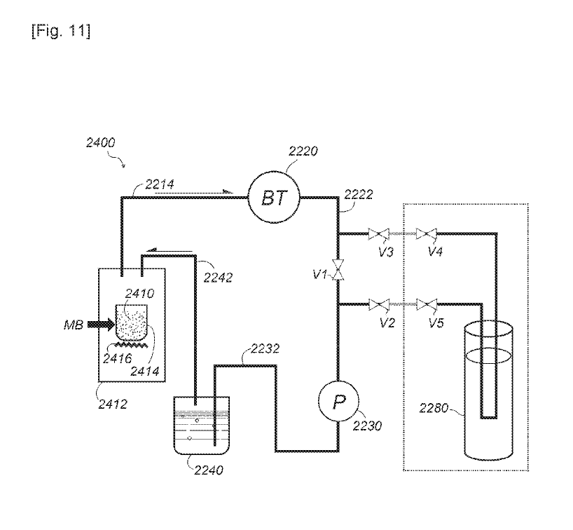

In the case of the on-line production method, muon irradiation for NMCR is carried out using a flow path for gas and liquid. FIGS. 10 and 11 are schematic configuration diagrams illustrating a processing apparatus for manufacturing ¹³³Xe by NMCR to be implemented in the present embodiment. FIG. 10 illustrates an irradiation processing apparatus 2200 for a liquid target material, and FIG. 11 illustrates an irradiation processing apparatus 2400 for a solid target material. On the liquid target 2210 in FIG. 10, the muon is irradiated by the same process as indicated for ⁹⁹Tc in FIG. 5. At that time, it is the sealed target container 2212 that corresponds to the liquid target material 1202. The sealed target container 2212 is filled with a liquid target 2210 together with helium gas to be a target of irradiation. During the muon beam MB irradiation, the valves V2 and V3 are closed and the valve V1 is kept open. A gas line 2214 is connected to the upper space of the sealed target container 2212 with its one end open, and the Xe gas liberated from the liquid target 2210 is collected from the headroom above the liquid level. The other end of the gas line 2214 is connected to the buffer tank 2220. The gas in the buffer tank 2220 is, via the gas line 2222, bubbled into the solution of the sealed aqueous solution trap 2240 by the gas line 2232, with the aid of the gas circulation pump 2230. From the above space of the liquid surface of the aqueous solution trap 2240, a path for bubbling into the liquid of the sealed target container 2210 through the gas line 2242 is established. In the aqueous solution trap 2240, an aqueous solution is stored from which Cs generated from Xe gas is to be recovered. As a result, Cs generated due to radioactive decay during circulation and Cs generated in the buffer tank 2220 is collected in the aqueous solution trap 2240. If the muon irradiation is continued with the gas circulation pump operated, the concentration of the Xe gas generated as a result of NMCR in the liquid target 2210 is increased in the helium gas while the recovery of Cs is continued in the aqueous solution trap 2240.

After the irradiation is completed, a suitable trap such as a liquid nitrogen trap 2280 is connected at the appropriate position along the path of the gas, then the valves V2 to V5 are opened while valve V1 is closed. Thereafter, by operating the gas circulation pump 2230, the Xe gas contained in the helium gas is collected into the liquid nitrogen trap 2280.

In the processing apparatus 2400 for targeting the solid Cs target of FIG. 11, an inner container 2414 that houses the solid Cs target 2410 is also positioned inside the sealed target container 2412 and is also filled with helium gas. A solid Cs target 2410 containing, ¹³⁴Cs, ¹³⁵Cs, ¹³⁷Cs and so on, which is a fine power, is contained in the inner container. This inner container 2414 is opened in the internal space of the sealed target container 2412, and the Xe gas liberated upon irradiation with muons is released to the inside of the sealed target container 2412. It is also preferred to have a temperature controller (e.g., heater 2416) for appropriately controlling the temperature of the solid Cs target to facilitate Xe gas release. The Cs generated by decay in the released Xe gas is collected in the aqueous solution trap 2240 according to the same method as in the case of the liquid Cs target.

In either of the liquid target and the solid target, it is not necessary to interrupt the irradiation of the muon, and the liquid nitrogen trap 2280 can be connected to recover the Xe gas in a timely manner. Thus, even when the muon beam intensity may become the rate-determining factor of the generation rate of ¹³³Xe, continuous irradiation can be performed to increase the production rate of ¹³³Xe.

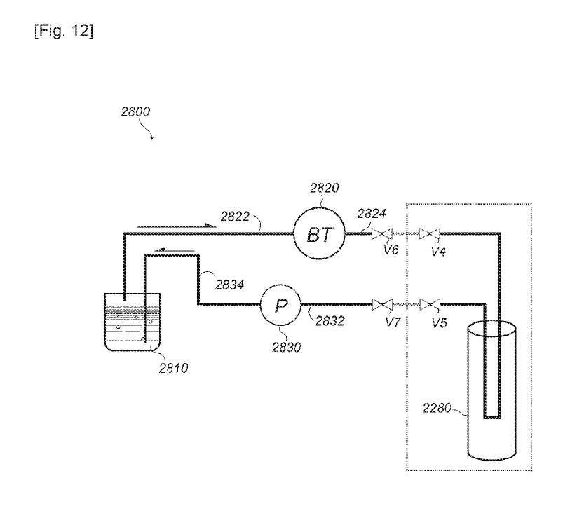

It is useful to recover ¹³³Cs, ¹³⁵Cs, ¹³⁷Cs produced by decay in an aqueous solution during at least one of the two cooling periods. FIG. 12 is a schematic configuration diagram illustrating the configuration of the Xe—Cs separation device 2800. In the first place, the liquid nitrogen trap 2280 used in the irradiation treatment apparatuses 2200 and 2400 (FIGS. 10 and 11) is connected to the Xe—Cs separation device 2800. Then, the liquid nitrogen is removed and the temperature of the liquid nitrogen trap 2280 is raised, whereby the Xe gas trapped in the liquid nitrogen trap 2280 is evaporated. The Xe gas is then circulated in a path provided with a suitable buffer tank 2820 and a gas circulation pump 2830 using helium as a circulating gas. A Cs ion trap 2810 has been inserted in the path. Since the gas blown into the Cs ion trap 2810 via the gas line 2832, the gas circulation pump 2830, and the gas line 2834 contains Cs that has been generated by decay of radioactive Xe, dissolving that gas into the aqueous solution of the Cs ion trap 2810 enables the mechanism of the separation and recovery at issue to function. By continuing circulation along the path from the Cs ion trap 2810 and back to the liquid nitrogen trap 2280 via the gas line 2822, the buffer tank 2820, and the gas line 2824, Cs generated by decay will be removed during the cooling period. After recovering the Cs ions, Xe gas containing ¹³³Xe can be recovered by injecting liquid nitrogen again into the liquid nitrogen trap 2280.

3-3. Production of ⁸⁹Rb-⁸⁹Sr from ⁹⁰Sr

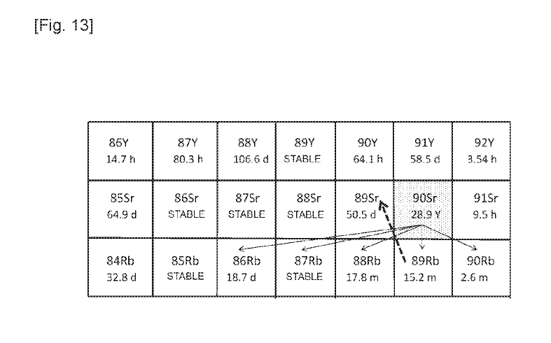

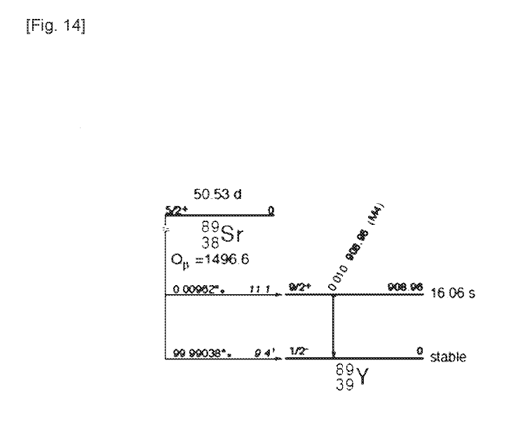

⁸⁹Sr can be produced from Sr raw material containing ⁹⁰Sr which is an LLFP contained in a high level radioactive waste. In nuclear medical applications, ⁸⁹Sr is used as an internal therapeutic agent for pain relief in the case of painful bone metastasis, where it releases β⁻ ray of maximum energy of about 1.49 MeV. It is a nuclide with a physical half-life of 50.5 days. FIG. 13 is an explanatory diagram illustrating the nuclear reaction on the chart of nuclides where Rb isotope is generated by NMCR adopting ⁹⁰Sr target. In addition, FIG. 14 is a decay scheme diagram between Sr and Y having a mass number A=89. ⁸⁹Sr is administered in the form of strontium chloride ⁸⁹SrCl₂ and the like, and it is intravenously administered to an adult 2.0 MBq/kg for a dose (in the case of 70 kg patient: 1.4×10⁸ Bq (3.8 mCi)). However, it is up to 141 MBq. For example, Japan imports 100% of the demand for ⁸⁹Sr. In this embodiment, about 0.6 kg of ⁹⁰Sr, which is a target nuclide, is contained in 1 ton of the high-level radioactive waste.

In the situation after using UO₂ fuel at a burnup of 45 GWd/tHM in a pressurized water reactor (PWR) and after cooling for 5 years, the ratio of isotopes of Sr contained in spent nuclear fuel is
⁸⁴Sr: 0.00%,
⁸⁵Sr: 0.00%,
⁸⁶Sr: 0.08%,
⁸⁷Sr: 0.00%,
⁸⁸Sr: 41.95%,
⁸⁹Sr: 0.00%, and
⁹⁰Sr: 57.97%
   (NPL5). Incidentally, the natural abundance ratio of Sr is
⁸⁴Sr: 0.56%,
⁸⁵Sr: 0.00%,
⁸⁶Sr: 9.86%,
⁸⁷Sr: 7.00%,
⁸⁸Sr: 82.58%,
⁸⁹Sr: 0.00%, and
⁹⁰Sr: 0.00%.

3-3-1. Process (Outline)

The process for producing ⁸⁹Sr from the Sr target material containing ⁹⁰Sr includes the following three steps:
Step 1: muon irradiation of the target material of Sr containing
Step 2: cooling of the separated and recovered Rb ions for 25 minutes, and
Step 3: cooling of Rb ions for another 150 minutes.

3-3-2. Details of Process

In Step 1, muon irradiation is performed on the target material of Sr containing ⁹⁰Sr for 90 minutes. Thereafter, after irradiating the muon, the Rb ion is separated and recovered from the Sr ion.

The reaction modes of NMCR using ⁹⁰Sr as the target nuclide are as follows:
⁹⁰Sr (μ⁻, v) ⁹⁰Rb (β⁻ decays into ⁹⁰Sr with a half-life of 2.6 minutes),
⁹⁰Sr (μ⁻, n v) ⁸⁹Rb (β⁻ decays into ⁸⁹Sr with a half-life of 15.2 minutes,
   ⁸⁹Sr then decays by β⁻ decay into ⁸⁹Y with a half-life of 50.5 days),
⁹⁰Sr⁻ (μ⁻, 2n v) ⁸⁸Rb (β⁻ decay into ⁸⁸Sr with a half-life of 17.8 minutes),
⁹⁰Sr (μ⁻, 3 n v) ⁸⁷Rb (stable, 4.8×10¹⁰ years), and
⁹⁰Sr (μ⁻, 4n v) ⁸⁶Rb (β⁻ decays into ⁸⁶Sr with a half-life of 18.7 days).
   The modes of nuclear reactions are understood from the chart of nuclides on FIG. 13. It should be noted that a Rb isotope is generated in the first place from each isotope of Sr and that, in the case NMCR occurs by targeting ⁹⁰Sr as a target nuclide and ⁸⁹Rb is generated thereafter, ⁸⁹Rb decays by β⁻ decay into ⁸⁹Sr in a short time (half-life of 15.2 minutes), and the half-life of generated ⁸⁹Sr becomes about 50.5 days, as indiated by a dashed line on FIG. 13.

Assuming identical beam conditions and identical reaction branching ratio to those for ⁹⁹Tc and ¹³³Xe described above, the reaction coefficients from Sr isotopic proportion of spent nuclear fuel to each Rb are calculated to be:
⁸⁴Rb: 0.0210,
⁸⁵Rb: 0.0629,
⁸⁶Rb: 0.1129,
⁸⁷Rb: 0.2967,
⁸⁸Rb: 0.1579,
⁸⁹Rb: 0.2899, and
⁹⁰Rb: 0.05797.

In Step 1, muon irradiation is performed for 90 minutes toward Sr solid or aqueous solution target containing ⁹⁰Sr. This irradiation time of 90 minutes is six times the ⁸⁹Rb half-life (15.2 minutes). After muon irradiation, Rb ions are separated and recovered from Sr ions. Then the radioactivity of ⁸⁹Rb becomes about 8.84×10¹² Bq.

Next, in Step 2, Rb ions are cooled for 25 minutes. This period is ten times of the half-life of ⁹⁰Rb half-life (2.6 min). As a result, ⁹⁰Rb decays by β⁻ decay into ⁹⁰Sr. ⁹⁰Sr is an LLFP. At this point, ⁸⁹Sr and ⁸⁸Sr, which are daughter nuclei of ⁸⁹Rb and ⁸⁸Rb respectively, are also mixed together. The ratio of radioisotopes (in atomic fraction) of Sr at this time is:
⁸⁴Sr: 0.0%,
⁸⁵Sr: 0.0%,
⁸⁶Sr: 0.09%,
⁸⁷Sr: 0.0%,
⁸⁸Sr: 35.3%,
⁸⁹Sr: 61.4%, and
⁹⁰Sr: 3.1%.
   The radioactivity ratio is:
⁸⁹Sr: 100.0% and
⁹⁰Sr: 0.02%.

Furthermore, in step 3, Rb ions separated from Sr are cooled for 150 minutes. This period is 10 times the half-life of ⁹⁰Rb half-life (15.2 minutes). In addition, ⁸⁸Rb, ⁸⁶Rb, ⁸⁴Rb are included. Among these, ⁸⁸Rb decays by β⁻ decay and becomes stable nucleus ⁸⁸Sr. ⁸⁶Rb and ⁸⁴Rb have a half-life of 18.7 days and 32.8 days respectively, and the numbers of decay are very small during cooling for 150 minutes. Sr ions are separated and recovered from the cooled Rb ions. The resulting ⁸⁹Sr can be used for nuclear medicine RI.

The isotope ratio (in atomic fraction) of Sr at this point is:
⁸⁶Sr: 1.1%,
⁸⁸Sr: 42.2%,
⁸⁹Sr: 56.7%, and
⁹⁰Sr: 0.008%.
   The radioactivity ratio is
⁸⁹Sr: 100.0%, and
⁹⁰Sr: 0.00007%.
   The radioactivity of ⁸⁹Sr generated according to the 90-minute irradiation is 5.90×10⁸ Bq (15.9 mCi). At 1 day (24 hours), it becomes 9.43×10⁹ Bq (255 mCi).

At the time when muon irradiation is carried out for 90 minutes and step 3 is completed, number N of ⁸⁹Sr in 1 g of produced Sr is given by

N=0.567/88.46×6.02×10²³=3.86×10²¹/g-Sr,

where the mass number (88.46) calculated from the isotopic distribution of the generated Sr is used. If the half-life of ⁸⁹Sr: T_{1/2}=50.5 days and decay constant of ⁸⁹Sr: λ=0.693/(50.5×24×3600)=1.58×10⁻⁷ (sec⁻¹) are adopted for this calculation, the specific radioactivity R of ⁸⁹Sr is calculated as:

R=λN=6.10×10¹⁴Bq/g-Sr

=610TBq/g-Sr.

This specific radioactivity of the ⁸⁹Sr is about 1.6 times 370 TBq/g-Mo, a specific radioactivity of ⁹⁹Mo obtained by the nuclear fission method (NPL4).

The production volume of ⁸⁹Sr per day per muon channel is 9.43×10⁹ Bq (255 mCi). Since the amount for a dose to a patient weighing 70 kg is 1.4×10⁸ Bq (3.8 mCi), the above-mentioned production amount per day corresponds to about 67 doses.

In relation to each step, a method for separating Sr ions from the Rb ions mentioned above will be described further. The separation method can be carried out by an ion exchange method and a precipitation method (or coprecipitation method). The ion exchange method is the same as the method for separating ⁹⁹Tc and ⁹⁹Mo described in FIG. 7. Since the Rb ion is a monovalent ion of an alkali metal and the Sr ion is a divalent ion of an alkaline earth metal, the same processing can be carried out by using an ion separation column utilizing the difference in ion valence and chemical properties. This also applies to the precipitation method.

The embodiments of the present invention have been concretely described above. Each of the above-described embodiments, specific examples, application examples, each theory and method of manufacturing for each nuclide are described for the purpose of explaining the invention, and the scope of the invention of the present application should be determined based on the claims. Also, modifications within the scope of the present invention including other combinations of the respective embodiments are also included in the scope of the claims.

### INDUSTRIAL APPLICABILITY

The method for producing the radioactive substance of the present invention and the substance to be produced can be used for any test, apparatus, diagnostic and analytical method using a radioactive substance, and nuclear medicine application.

### REFERENCE SIGNS LIST

100 nuclear fuel cycle
10 uranium mine
12 uranium
20 fuel processing plant
22 fuel
30 nuclear power plant
32 spent nuclear fuel
34 low level radioactive waste
40 low level radioactive waste disposal facility
50 reprocessing plant
52 recovered uranium and plutonium
54 high level radioactive waste
60 high-level radioactive waste storage facility
70 high-level radioactive waste disposal facility
1200 manufacturing apparatus
1202 liquid target raw material
1210A, B system
1212A, B column
1220 pump
1400 batch manufacturing process
1402 target material
1404 container
1600 process of ion exchange processing
1612 solid ⁹⁹Tc Target
1620, 1640, 1650, 1660 aqueous solution
1614 liquid ⁹⁹Tc target
1630 ion separation column
2200, 2400 irradiation treatment device
2210 liquid target
2212 sealed target container
2214, 2222, 2232, 2242 gas line
2220, 2820 buffer tank
2230, 2830 gas circulation pump
2280 liquid nitrogen trap
2410 solid Cs target
2412 sealed target container
2414 inner container
2416 heater (temperature controller)
2800 Xe—Cs separation device
2240, 2810 Cs ion trap
2822, 2824, 2832, 2834 gas line
MB muon beam
LS liquid flow

1. A method for producing a radioactive substance comprising a muon irradiation step for obtaining a first radionuclide through a muon nuclear capture reaction by irradiating a target nuclide which is a radionuclide with negative muons,
wherein the radioactive substance to be produced comprises at least one of the first radionuclide and a second radionuclide, the second radionuclide being a descendant nuclide obtained from the first radionuclide via radioactive decay.

2. The method for producing a radioactive substance according to claim 1 further comprising preparing a target raw material containing the target nuclide to be irradiated with negative muon prior to the muon irradiation step,
wherein the target nuclide in the target raw material is any of radionuclides in long-lived fission products (LLFPs) contained in a spent nuclear fuel or a substance separated from a spent nuclear fuel.

3. The method for producing a radioactive substance according to claim 2, wherein the target nuclide is ⁹⁹Tc, the first radionuclide is ⁹⁹Mo, and the second radionuclide is ^{99m}Tc.

4. The method for producing a radioactive substance according to claim 1,
wherein the target nuclide is ⁹⁹Tc, the first radionuclide is ⁹⁹Mo, and the second radionuclide is ^{99m}Tc,
further comprising a step of preparing a target material to be irradiated with negative muons prior to the muon irradiation step,
wherein the target material is a recycled raw material containing at least any of ⁹⁹Tc produced as a by-product in an arbitrary step until a ⁹⁹Mo-^{99m}Tc generator is manufactured, ⁹⁹Tc obtained in a left over substance of an unused pharmaceutical preparation, and ⁹⁹Tc produced after radioactive decay in the ⁹⁹Mo-^{99m}Tc generator.

5. The method for producing a radioactive substance according to claim 3, wherein the muon irradiation step is performed for an irradiation time shorter than 66 hours, which is a half-life of ⁹⁹Mo.

6. The method for producing a radioactive substance according to claim 3, further comprising a collection step of ⁹⁹Mo ion from a substance containing ⁹⁹Tc ion which is an ion of the target nuclide by adsorbing ⁹⁹Mo ion which is an ion of the first radionuclide onto an ion exchange column.

7. The method for producing a radioactive substance according to claim 2, wherein the target nuclide includes at least one nuclide selected from a group of nuclides consisting of ¹³⁴Cs, ¹³⁵Cs, and ¹³⁷Cs, and the first radionuclide is ¹³³Xe.

8. The method for producing a radioactive substance according to claim 2, wherein the target nuclide is ⁹⁰Sr, the first radionuclide is ⁸⁹Rb, and the second radionuclide is ⁸⁹Sr.

9. The method for producing a radioactive substance according to claim 1 further comprising:
an unloading step of an irradiated fluid containing the first radionuclide or the second radionuclide and a fluid medium from an irradiation position of the negative muon by transferring the fluid medium, the first radionuclide or the second radionuclide having been obtained from the target nuclide in the muon irradiation step;
a collecting step for selectively collecting the first radionuclide or the second radionuclide from the irradiated fluid; and
a reloading step for repositioning the irradiated fluid that has undergone the collecting step into the irradiation position by transferring the fluid medium.

10. The method for producing a radioactive substance according to claim 9, wherein the unloading step, the collecting step, and the reloading step are performed in parallel while the muon irradiation step is continuously performed.

11. A radioactive substance comprising at least one of a first radionuclide and a second radionuclide, the first radionuclide obtained through a muon nuclear capture reaction by irradiating a target nuclide with negative muons, and the second radionuclide being at least one descendant nuclide obtained from the first radionuclide via radioactive decay, wherein the target nuclide is a radionuclide.

12. The radioactive substance according to claim 11, wherein the target nuclide is any of radionuclides in long-lived fission products (LLFPs) contained in a spent nuclear fuel or a substance separated from a spent nuclear fuel.

13. The radioactive substance according to claim 12, wherein the target nuclide is ⁹⁹Tc, the first radionuclide is ⁹⁹Mo, and the second radionuclide is ^{99m}Tc.

14. The radioactive substance according to claim 11,
wherein the target nuclide is ⁹⁹Tc, the first radionuclide is ⁹⁹Mo, and the second radionuclide is ^{99m}Tc, and
wherein a target material to be irradiated with negative muons is a recycled raw material containing at least any of ⁹⁹Tc produced as a by-product in an arbitrary step until a ⁹⁹Mo-^{99m}Tc generator is manufactured, ⁹⁹Tc obtained in a left over substance of an unused pharmaceutical preparation, and ⁹⁹Tc produced after radioactive decay in the ⁹⁹Mo-^{99m}Tc generator.

15. The radioactive substance according to claim 12, wherein the target nuclide includes at least one nuclide selected from a group of nuclides consisting of ¹³⁴Cs, ¹³⁵Cs, and ¹³⁷Cs, and the first radionuclide is ¹³³Xe.

16. The radioactive substance according to claim 12, wherein the target nuclide is ⁹⁰Sr, the first radionuclide is ⁸⁹Rb, and the second radionuclide is ⁸⁹Sr.
